(19) United States
(12) Patent Application Publication
(10) Pub. No.: US 2016/0266071 A1
(43) Pub. Date: Sep. 15, 2016

(54) ITEM OF EQUIPMENT FOR ULTRASONIC NON-DESTRUCTIVE INSPECTION

(71) Applicant: AIRBUS GROUP SAS, BLAGNAC (FR)

(72) Inventors: FRANCK BENTOUHAMI, CHAVANNES EN PAILLERS (FR); LOUIS LE PINRU, REZE (FR)

(21) Appl. No.: 15/034,139

(22) PCT Filed: Nov. 5, 2014
(86) PCT No.: PCT/FR2014/052813

§ 371 Date: May 3, 2016

(30) Foreign Application Priority Data
Nov. 5, 2013 (FR) 1360829

(51) Int. Cl. G01N 29/22; G01N 29/28

(52) U.S. Cl. CPC G01N 29/223; G01N 29/28

(57) ABSTRACT

A device to hold a piece for an item of equipment for ultrasonic measurement. This device has a hollow body, which is substantially tubular, a first end of which can be applied against a surface of the piece and a second opposite end can be connected to a suction element. The hollow body is made from rigid material and the device includes a peripheral joint associated with the first end.

The present invention relates to an item of equipment for ultrasonic non-destructive inspection.

More particularly, the invention relates to an item of equipment for ultrasonic non-destructive inspection of a structural piece in which the piece is held in position in order to be inspected by means of a holder device in an enclosure of the item of equipment.

It is known to carry out non-destructive inspection of a piece, for example a piece made from a composite or metallic material, using an ultrasonic item of equipment.

An item of equipment of this type for ultrasonic measurement may be equipped with a laser source for generating an ultrasonic beam in a chamber of the item of equipment and, with the beam, scanning the piece to be measured, which is positioned in said chamber. An item of equipment of this type for measurement makes it possible to obtain an ultrasonic map of the homogeneity and of the integrity of the piece. A measurement of this type is conventionally performed in a chamber containing air. It is, however, possible to carry out this type of measurement in a chamber containing another fluid, such as water.

During measurement, the piece has to be stable and is thus arranged on a holder and can be held, if necessary, by different holder elements, such as flanges, for example. In certain devices, the holder is connected to a suction means that creates a reduced pressure under the piece in order to press the latter against the holder and thus to stabilize the piece during measurement.

One of the problems presented by a device of this type is that activation of the suction means generates a large contact surface between the piece and the holder device. This contact surface is generally visible on the ultrasonic map of results and may appear as a homogeneity defect over an intact zone of the piece and/or mask a defect in the zone in contact with the holder, which comprises, for example, suction cups.

The object of the present invention is to in part or in full remedy the aforesaid disadvantages.

To that end, an item of equipment for ultrasonic non-destructive inspection, comprising a measurement enclosure for receiving a piece for inspection, comprising a source producing, in the measurement enclosure, while the item of equipment is functioning, an ultrasonic beam such as to produce an image of a surface of the piece to be inspected.

The item of equipment further comprises at least one holder device arranged in the measurement enclosure to support the piece in a stable position required for performing scanning by the ultrasonic beam, said holder device comprising a hollow body connected to means for creating a reduced pressure in an interior volume of said hollow body and of which an edge forms a support surface for the piece and comprises at least one peripheral joint, such that:

a—said peripheral joint is placed on the support surface such that said joint is interposed between said support surface and the piece when said piece is undergoing inspection such that said piece is not in direct contact with the hollow body;

b—said peripheral joint seals the fluid present in the enclosure between an interior volume at reduced pressure of the hollow body and said enclosure;

c—said peripheral joint determines, with the piece, a contact surface of which a width is substantially less than a resolution of the image of the surface of the piece produced by the item of equipment.

Thus, the piece, such as a metallic structural piece or one made from composite material, is held in a stable manner while an ultrasonic non-destructive inspection is carried out, without the means providing the support for the piece being seen by the ultrasonic measurement creating an image of the piece, which means, were they not to appear transparent, would be likely to mask defects in the piece.

In one embodiment, the at least one joint has a substantially circular cross section when no piece is held by the holder device. This results in a simply joint to be produced, which, when the piece is being supported, bears, seen in the cross section of the joint, on a point of the circle and is thus necessarily small in size even after a slight crushing of the joint when the reduced pressure is created in order to hold the piece.

In one embodiment, a mean diameter of the cross section of the at least one joint is substantially less than the resolution of the image of the surface of the piece produced by the item of equipment when no piece is held by the holder device.

In one embodiment, the at least one joint has a substantially square or a trapezoidal cross section and a length of a side of the square or of the small base of the trapezium is substantially less than the resolution of the image of the surface of the piece produced by the item of equipment when no piece is held by the holder device.

In one embodiment, the at least one joint has a triangular cross section when no piece is held by the holder device, said joint being placed such that the piece comes to bear on an apex of the triangle.

In accordance with these various embodiments, a controlled width is achieved for the contact surface between the joint and the piece such as to guarantee that this width remains less than the defined resolution.

In one embodiment, the at least one joint has a cross section with multiple lobes, and in particular comprises three, four, or five lobes. The possibilities for supporting the joint on the piece are thus multiplied and, by distribution of forces, there is less crushing of the joint, resulting in smaller contact widths that enhance the invisibility of said contact surfaces on the images produced in the course of the inspection.

In one embodiment, the support surface comprises a peripheral groove in which the at least one joint is engaged. The joint is thus held better and perfectly positioned during placing of the piece, thereby facilitating the operation of arranging the piece.

Advantageously, when the fluid in which the ultrasonic beam propagates is a liquid, the material constituting the joint is an elastomer, for example an AQUALENE™, of which an acoustic impedance is substantially identical to that of said liquid. The joint then becomes invisible to ultrasound, even if the dimensions of the joint do not at all points comply with the dimensional constraints imposed by the resolution of the image produced.

In one embodiment, the item of equipment makes use of a laser source to emit a laser spot generating an ultrasonic beam and to carry out rapid scanning of the piece.

Other features, details and advantages of the invention will become more clearly apparent from the following detailed description that is given by way of indication in connection with the drawings, in which:

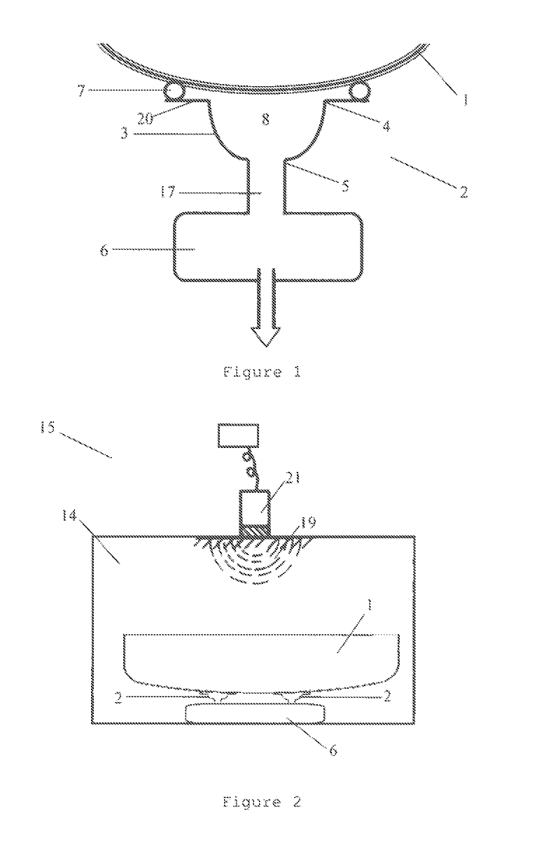

FIG. 1 shows a holder device according to one embodiment used in an item of equipment for ultrasonic non-destructive inspection according to the invention;

FIG. 2 shows an item of equipment for ultrasonic non-destructive inspection according to the invention in which a piece is held in a measurement enclosure by two holder devices such as the holder device of FIG. 1;

FIGS. 3a and 3b show different shapes of transverse section of a joint of holder devices;

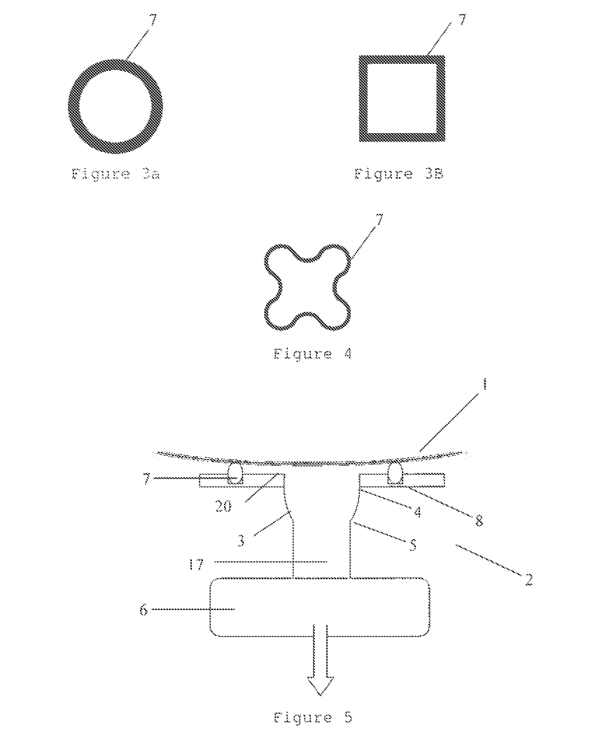

FIG. 4 is a top view of a joint of the holder device according to a variant embodiment of the device; and

FIG. 5 illustrates a variant of a holder device for an item of equipment for ultrasonic non-destructive inspection according to the invention.

In all these figures, identical references denote identical or similar elements.

In the figures, the different parts are not necessarily represented on the same scale.

FIG. 2 represents a schematic view of an item of equipment 15 for ultrasonic non-destructive inspection, which comprises a measurement enclosure 14 in which a piece 1 to be inspected is placed.

The item of equipment 15 comprises a source 21 producing, in the measurement enclosure 14, while the equipment is functioning, an ultrasonic beam 19 scanning a surface of the piece 1 to be inspected.

The item of equipment also comprises a holder device 2 arranged in the measurement enclosure 14 for holding the piece 1 in a required position in order to carry out scanning using the ultrasonic beam and to hold the piece with the necessary stability for the measurements.

FIG. 1 shows an isolated example of a holder device 2 on which a piece 1 is positioned, without the other elements of the item of equipment 15.

The device 2 comprises a substantially tubular hollow body 3. The hollow body 3 may have a section, in transverse cross section, perpendicular to a substantially vertical axis of said hollow body, of any shape, for example circular or ellipsoid, or even polygonal, square or the like. At a first end 4, the hollow body 3 comprises edges forming a support surface 20 for the piece 1. At a second end 5, the hollow body 3 is configured in order to be connected to a suction means 6. To that end, the end 5 is, for example, connected to a first end of a pipe 17, a second end of which is connected to a suction means 6.

The hollow body 3 of the device 2 is formed from a rigid material such as, by way of indication, a metal or a rigid polymer. The term “rigid” in this description means that the material of the hollow body 3 is able to withstand, without becoming substantively deformed, at the scale of the piece and given the measurements performed, a reduced pressure created by the suction means 6.

As may be understood from the overall view of FIG. 2, the hollow body 3, in addition to the reduced pressure formed by the suction means, transmits the forces generated by the weight of the piece 1 to holder means (not shown) located advantageously in the measurement enclosure, and in this connection the resistance and the rigidity of the hollow body are adapted to withstand these forces linked to the weight of the piece in combination with the effects of the reduced pressure.

It should therefore be noted that the piece may have variable positioning for one piece as compared to another or for one item of equipment for non-destructive inspection as compared to another. In the example illustrated in FIG. 2, the piece is held in a substantially horizontal position, considering a general form of the piece and from beneath, the ultrasound source being placed above. In one embodiment (not illustrated), the piece is held in a substantially vertical position, for example in the case of an ultrasound source placed laterally in the measurement enclosure. In one embodiment (not illustrated), the piece is held in a substantially horizontal, but suspended, position, for example in the case of an ultrasound source placed in a low position in the measurement enclosure.

It should be noted that the value of the reduced pressure is connected with the stress required for holding the piece 1. The minimum value of this holding stress is generally correlated with the weight of the piece 1 that is supported by the hollow body 3.

The device 2 also comprises a peripheral joint 7 placed on the support surface 20 for interposing between the piece 1 and the first end 4 when said piece is in the enclosure 14.

The joint 7 is a peripheral joint extending lengthways over the support surface 20 such as to close a perimeter of the first end 4.

The form of a cross section of the joint 7 is not imposed and, for example, may be circular or polygonal, hollow or solid, or have other forms adapted for supporting the piece 1, provided the conditions to be detailed below are fulfilled.

Advantageously, the form and the dimensions of the first end 4 form a support surface 20 that is sufficient to hold the joint 7 and to guarantee, by means of the reduced pressure, sufficient forces to hold the piece 1 without recourse to the use of tools such as clamps.

As shown in FIG. 1, the joint 7 is arranged on the hollow body 3, such that it is positioned between the latter and the piece 1, when the device 2 and the piece 1 are in position for the inspection.

The support surface 20 and the joint 7 are also dimensioned in order that the hollow body 3 is not placed in direct contact with the piece 1, but in order that the piece bears on said joint during the inspection.

The joint 7 is deformable and adapts to the form of a surface of the piece 1, this form of the piece being linked to the definition of the piece and/or to imperfections in its surface, in line with the zone of support of said joint on the piece 1.

Activation of the suction means 6 creates a reduced pressure in the hollow body 3, which has the effect of applying a force on the pieces 1 crushing the joint 7, which crushing results in continuous contact of said piece on said joint and continuity between the device 2 and the surface of the piece 1.

Once the joint 7 has deformed, the piece 1 is pressed against the joint 7 and held in position by the device 2, and produces a sufficient seal for the fluid contained in the measurement enclosure at the hollow body 3/piece 1 interface to conserve a required reduced pressure in the hollow body, in order to keep said piece stationary during the inspection.

This result is obtained with a joint 7 produced from a material that is able to deform reversibly when the suction means is activated.

Furthermore, the joint must not disrupt the ultrasonic beam during scanning of the piece in order not to appear on a results map.

In order to obtain this result, the width dimension of the contact surface between the joint and the piece 1 must be as small as possible in order to be less than the resolution of the ultrasonic analysis. The cross section of the joint is thus determined in order that, in combination with a resistance to crushing of said joint when the reduced pressure holds the piece against said joint, this condition pertaining to the width of the contact surface can be fulfilled.

As far as possible, the joint 7 is produced in a material of which the acoustic impedance is of the same order of magnitude as the acoustic impedance of the fluid present in the measurement enclosure 14.

The ultrasonic measurements may typically be carried out in air, in water or, alternatively, in other media likely to fill the measurement enclosure 14.

The above condition pertaining to impedance is nowadays practically impossible to achieve effectively in the case of measurements in an air environment, and in such cases it is important to comply with the dimensional conditions on the contact surface between the joint and the piece.

When ultrasonic measurement is carried out in an aqueous environment, the joint is advantageously made from an elastomer material, such as the elastomer distributed under the name AQUALENE™ by the Olympus company, the acoustic impedance of which is close to that of water.

Generally, a joint 7 is advantageously designed for each different measurement environment, with the material having an acoustic impedance as close as possible to that of the measurement environment and, furthermore, exhibiting elastic and dimensional characteristics adapted to the production of the joint 7.

As shown in FIGS. 3a and 3b, the joint 7 may have transverse cross sections of different forms. The forms in question are shown empty, i.e. not deformed by reduced pressure being applied to the piece being supported in the item of equipment.

The circular form of FIG. 3a may be solid or hollow such as to be adapted to the rigidity of the material used to form said joint and to confer on said joint the flexibility needed for the seal to be created and the low crushing characteristic in order to obtain a small width for the contact surface relative to the resolution of the measurement performed by the item of equipment for inspection.

It should thus be understood that these features are also dependent on the value of the reduced pressure created in the hollow body 3 and on a surface delimited on the piece 1 by the peripheral joint 7. It is thus possible to limit the formation of the joint by crushing and thus the width of the contact surface, and, if the mass of the piece to be held so justifies, to multiply the number of holder devices 2 as much as necessary.

The square form of FIG. 3b, which may be solid or hollow, is a priori advantageous only insofar as the length of the side of the square is less than the resolution of the measurements carried out by the system 15. This form offers the advantage of a controlled width of the width of the contact surface between the joint and the piece, which width is substantially constant, within certain limits of reduced pressure.

Another form (not shown) of transverse cross sections of joints, for example triangular or trapezoidal, or, alternatively, polygonal, cross sections, are adapted to forming a joint/piece contact surface of small, controlled width. In the case of triangular or trapezoidal cross sections, the piece is advantageously placed such that the piece bears on an apex of the triangle or a small base of the trapezium.

In one illustrative embodiment, the ultrasound source 21 is a laser source generating an ultrasonic beam 19 forming a mark or spot that will scan the piece 1.

As a function of the characteristics of the ultrasound source 21, which are chosen in keeping with a resolution of the item of equipment 15 for non-destructive inspection, the spot has dimensions, for example a mean diameter, that are more or less large.

In order to remain invisible during the inspection of the piece, at least in order not to disrupt interpretation of the inspection, the width of the joint 7 in contact with the piece 1 is less than the mean diameter of the spot formed by the ultrasonic beam 19 of the item of equipment 15 for measurement.

For example, when the mean diameter of the spot of the item of equipment for measurement is 3 millimeters, the width of the joint 7 in contact with the piece 1 has to be substantially less than 3 millimeters, and this result is, for example, obtained with an external diameter for a circular cross section of the joint of FIG. 3a, or a width for a square transverse cross section of the joint of FIG. 3b, for example of 2 or 2.5 millimeters.

Thus, under these conditions, when the ultrasonic beam 19 scans the piece 1 placed on the joint 7 of the holder device 2, the joint 7 is not detected by the item of equipment 15 for inspection.

In one embodiment, the joint 7 has a cross-section of multi-lobed form, for example a four-lobed form, as in the example illustrated in FIG. 4.

In this form, the deformation capabilities of the joint to achieve the required seal between the hollow body 3 and the piece 1 are provided by the lobes, and the contact surface between the piece and the joint is distributed between the lobes, the result of this being a reduction in the width of these contact zones in order, through the choice adapted to the material, the dimensions and the reduced pressure, to keep said contact zones invisible.

It should be noted that results similar to those for a four-lobed joint are obtained with a two-lobed or three-lobed joint, or with a joint with five or even more lobes, provided the relief of the lobes is sufficiently accentuated in form to provide the deformation capabilities expected of the joint, sufficient to provide the seal but without excess, in order that the piece 1 does not come into contact with the support surface 20, and the geometric characteristics required for each of the lobes in contact with the pieces 1.

As shown in FIG. 2, a piece 1 may be held by a plurality of devices 2, and is preferably held by a plurality of devices 2.

In this case, the devices 2 are, in one embodiment, all connected to the same suction means 6.

However, preferably the devices 2, the holder for the piece 1, will be distributed between two or more suction means 6 such that, in the event of the failure of one suction means, the piece 1 continues to be held and there is no risk of its falling in the measurement enclosure 14, particularly in the case of vertical holding of the piece.

Naturally, the present invention is not limited to the embodiment described above and may extend to any variant embodiment in accordance with the spirit of the invention.

In one embodiment, as shown in FIG. 5, the support surface 20 of the hollow body 3 has a groove 8 in which the peripheral joint 7 is engaged such as to be held on the support surface 20 and thus to facilitate the placement of the piece 1 without risking displacement of the joint, which could lead to a sealing defect.

In the case of ultrasonic non-destructive inspection in a liquid environment, the present invention can be used where a map of the piece 1 is produced with an item of equipment for inspection equipped with nozzles spraying a jet of liquid to propagate the ultrasonic beam in an enclosure containing essentially air, or with an item of equipment immersing a limited zone of the piece, a device known as “liquid boxes”, or totally immersing the piece in a tank.

1-10. (canceled)

11. An item of equipment for ultrasonic non-destructive inspection, comprising:
a measurement enclosure to receive a piece for inspection;
a source to produce an ultrasonic beam in the measurement enclosure to produce an image of a surface of the piece to be inspected;
at least one holder device arranged in the measurement enclosure to support the piece in a stable position required for performing scanning by the ultrasonic beam, said holder device comprises a hollow body connected to a device to generate a reduced pressure in an interior volume of the hollow body and of which an edge forms a support surface for the piece and comprises at least one peripheral joint;
wherein said peripheral joint is placed on the support surface such that said peripheral joint is interposed between the support surface and the piece undergoing inspection such that the piece is not in direct contact with the hollow body;
wherein said peripheral joint seals a fluid present in the measurement enclosure between the interior volume at reduced pressure of the hollow body and the measurement enclosure; and
wherein said peripheral joint determines, with the piece, a contact surface having a width substantially less than a resolution of the image of the surface of the piece produced by the item of equipment.

12. The item of equipment as claimed in claim 11, wherein said peripheral joint has a substantially circular cross section when no piece is held by said holder device.

13. The item of equipment as claimed in claim 12, wherein a mean diameter of the cross section of said peripheral joint is substantially less than the resolution of the image of the surface of the piece produced by the item of equipment when no piece is held by said holder device.

14. The item of equipment as claimed in claim 11, wherein said peripheral joint has a substantially square or a trapezoidal cross section and a length of a side of the square or a small base of the trapezium is substantially less than the resolution of the image of the surface of the piece produced by the item of equipment when no piece is held by said holder device.

15. The item of equipment as claimed in claim 11, wherein said peripheral joint has a triangular cross section when no piece is held by the holder device, said peripheral joint being placed such that the piece comes to bear on an apex of the triangle.

16. The item of equipment as claimed in claim 11, wherein said peripheral joint has a cross section with multiple lobes.

17. The item of equipment as claimed in claim 16, wherein said peripheral joint comprises three, four or five lobes.

18. The item of equipment as claimed in claim 11, wherein the support surface comprises a peripheral groove in which said one peripheral joint is engaged.

19. The item of equipment as claimed in claim 11, wherein a fluid in which the ultrasonic beam propagates is a liquid, and wherein a material constituting said peripheral joint is an elastomer of which an acoustic impedance is substantially identical to that of the liquid.

20. The item of equipment as claimed in claim 11, wherein the source is a laser source emitting a laser spot to generate the ultrasonic beam.
